(19) United States
(12) Patent Application Publication
(10) Pub. No.: US 2012/0001476 A1
(43) Pub. Date: Jan. 5, 2012

(54) INJECTION MOLDED COMPOSITE WHEEL FOR A VEHICLE

(75) Inventors: Shengmei Yuan, Newark, DE (US); Karl Paul Maurer, North Branch, MN (US)

(73) Assignee: E.I. DU PONT DE NEMOURS AND COMPANY, Wilmington, DE (US)

(21) Appl. No.: 13/170,596

(22) Filed: Jun. 28, 2011

Related U.S. Application Data
(60) Provisional application No. 61/359,980, filed on Jun. 30, 2010.

(51) Int. Cl. C08L 77/06; C08K 7/14; B60B 5/02; C08K 7/06

(52) U.S. Cl. 301/5.1; 524/606; 524/607

(57) ABSTRACT

Disclosed is a injection molded composite wheel, including a polyamide composition including (A) about 20 to about 70 weight percent of at least one polyamide resin, (B) about 30 to about 65 weight percent of one or more fiber reinforcing agents wherein the fiber has an average length of 0.1 to 0.9 mm; and (C) 0 to about 20 weight percent of one or more polymer impact modifiers; wherein 4 mm test bars prepared from the polyamide composition have an average tensile modulus greater than or equal to about 9 GPa, and an elongation at break of at least 4%.

### CROSS REFERENCE TO RELATED APPLICATIONS

This application claims the benefit of U.S. Provisional Application No. 61/359,980 filed Jun. 30, 2010, which is incorporated herein by reference in its entirety.

### FIELD OF INVENTION

The present invention relates to the field of injection molded composite wheels for a vehicle including motorized vehicles.

### BACKGROUND OF INVENTION

Weight reduction in all types of vehicles, including motorized vehicles, is an approach to improve the energy efficiency of vehicles. Glass reinforced plastics have been a key candidate to replace metal to reduce weight of vehicles. A plastic wheel rim is one example. Low density reinforced plastics have been a key factor for plastic wheels in bicycle, all terrain-vehicle (ATV), utility vehicle (UTV), and potentially automotive vehicle.

However, thermoplastics have lower strength and modulus compared to metal. Fiber reinforcement significantly improves strength and modulus of thermoplastics but reduces elongation at break and ultimately makes plastic more brittle. It is desirable to have a reinforced thermoplastic with high strength, high stiffness, and high elongation. Most 30˜40 weight percent fiber reinforced thermoplastic polyamides and other polymers give 10-12 Gpa tensile modulus and 2.5-3.0% elongation at break.

U.S. Pat. No. 4,072,358 discloses a compression molded cut glass fiber reinforced plastic wheel, said cut glass fibers being from 0.125 to 1.5 inches in length.

U.S. Pat. No. 5,277,479 discloses a resin wheel comprising a rim and a disk molded integrally, and the wheel is formed by injection molding a fiber-reinforced thermoplastic resin wherein the fiber-reinforced thermoplastic resin comprises short fibers (0.1-0.5 mm) and long-fibers (>1 mm).

Elongation is a key indicator for material toughness. Toughness is a measure of the energy a sample can absorb before it breaks. The energy absorption is characterized by an area under stress-strain curve in tensile testing. For compositions having tensile strength, the longer the elongation at break, the higher the energy absorption, and the higher the toughness.

Needed are fiber reinforced wheels that can be manufactured by inexpensive injection molding processes, and exhibit high tensile modulus, that is, greater or equal to 9 Gpa, and high elongation at break, that is, greater or equal to 4% elongation at break. Such fiber reinforced wheels would provide the toughness properties satisfactory for many vehicle applications.

### SUMMARY OF INVENTION

Disclosed is an injection molded composite wheel, comprising a polyamide composition consisting essentially of
(A) about 20 to about 70 weight percent of at least one polyamide resin comprising,
   (i) about 60 to 100 mole percent of repeat units derived from one or more aliphatic dicarboxylic acids and one or more aliphatic diamines, wherein at least about 50 mole percent of the aliphatic dicarboxylic acids and aliphatic diamines are aliphatic dicarboxylic acids and/or aliphatic diamines that have 10 or more carbon atoms,
   (ii) 0 to about 40 mole percent of repeat units derived from one or more aromatic dicarboxylic acids, and
(B) about 30 to about 65 weight percent of one or more fiber reinforcing agents wherein said fiber has an average length of 0.1 to 0.9 mm; and
(C) 0 to about 20 weight percent of one or more polymer impact modifiers;
   wherein the weight percentages of (A), (B), and (C) are based on the total weight of (A)+(B)+(C), and wherein 4 mm test bars prepared from said polyamide composition have an average tensile modulus greater than or equal to about 9 GPa, as measured by ISO 527-1/2 and an elongation at break of at least 4% as tested according to ISO 527-2/1A, with the proviso that when said at least one polyamide resin consists of PA610, at least 2 weight percent of one or more polymer impact modifiers is present.

### BRIEF DESCRIPTION OF THE DRAWINGS

FIG. 1 is a cross-sectional view of a wheel test specimen used in an upward and downward (throw-down) impact test.

FIG. 2 illustrates an idealized stress-strain curve.

### DETAILED DESCRIPTION OF THE INVENTION

By a “vehicle” is meant any device which moves which is on wheels and transports people and/or freight or performs other functions. The vehicle may be self propelled or not. Applicable vehicles include automobiles, motorcycles, wheeled construction vehicles, farm or lawn tractors, all terrain vehicles (ATVs), trucks, trailers, bicycles, carriages, shopping carts, wheel barrows, and dollies.

The injection molded composite wheel, comprises a polyamide composition comprising (A) about 20 to about 70 weight percent of at least one polyamide resin, about 30 to about 65 weight percent of one or more fiber reinforcing agents wherein said fiber has an average length of 0.1 to 0.9 mm; and (C) 0 to about 20 weight percent of one or more polymer impact modifiers.

Preferably the injection molded composite wheel consists essentially of (A) about 20 to about 70 weight percent of at least one polyamide resin, about 30 to about 65 weight percent of one or more fiber reinforcing agents wherein said fiber has an average length of 0.1 to 0.9 mm; and (C) 0 to about 20 weight percent of one or more polymer impact modifiers.

Another embodiment is an injection molded composite wheel that consists essentially of (A) about 20 to about 68 weight percent of at least one polyamide resin, (B) about 30 to about 65 weight percent of one or more fiber reinforcing agents wherein said fiber has an average length of 0.1 to 0.9 mm; and (C) 2 to about 20 weight percent of one or more polymer impact modifiers.

Another embodiment is an injection molded composite wheel that consists essentially of (A) about 25 to about 65 weight percent of at least one polyamide resin, (B) about 30 to about 65 weight percent of one or more fiber reinforcing agents wherein said fiber has an average length of 0.1 to 0.9 mm; and (C) 5 to about 12 weight percent of one or more polymer impact modifiers.

The polyamide resin used in the present invention has a melting point and/or glass transition. Herein melting points and glass transitions are as determined with differential scanning calorimetry (DSC) at a scan rate of 10° C./min, wherein the melting point is taken at the maximum of the endothermic peak and the glass transition, if evident, is considered the mid-point of the change in enthalpy.

Polyamides are condensation products of one or more dicarboxylic acids and one or more diamines, and/or one or more aminocarboxylic acids, and/or ring-opening polymerization products of one or more cyclic lactams. Suitable cyclic lactams are caprolactam and laurolactam. Polyamides may be fully aliphatic or semi-aromatic.

Fully aliphatic polyamides used in the resin composition of the present invention are formed from aliphatic and alicyclic monomers such as diamines, dicarboxylic acids, lactams, aminocarboxylic acids, and their reactive equivalents. A suitable aminocarboxylic acid is 11-aminododecanoic acid. Suitable lactams are caprolactam and laurolactam. In the context of this invention, the term “fully aliphatic polyamide” also refers to copolymers derived from two or more such monomers and blends of two or more fully aliphatic polyamides. Linear, branched, and cyclic monomers may be used.

The semi-aromatic polyamide is a copolymer, a terpolymer or more advanced polymers formed from monomers containing aromatic groups.

Preferred polyamides disclosed herein are homopolymers or copolymers wherein the term copolymer refers to polyamides that have two or more amide and/or diamide molecular repeat units. The homopolymers and copolymers are identified by their respective repeat units. For copolymers disclosed herein, the repeat units are listed in decreasing order of mole % repeat units present in the copolymer. The following list exemplifies the abbreviations used to identify monomers and repeat units in the homopolymer and copolymer polyamides (PA):
HMD hexamethylene diamine (or 6 when used in combination with a diacid)
T Terephthalic acid
AA Adipic acid (or 6 when used in combination with a diamine)
DMD Decamethylenediamine
6 [symbol] -Caprolactam
DDA Decanedioic acid
DDDA Dodecanedioic acid
I Isophthalic acid
MXD meta-xylylene diamine
TMD 1,4-tetramethylene diamine
4T polymer repeat unit formed from TMD and T
6T polymer repeat unit formed from HMD and T
DT polymer repeat unit formed from 2-MPMD and T
MXD6 polymer repeat unit formed from MXD and AA
66 polymer repeat unit formed from HMD and AA
10T polymer repeat unit formed from DMD and T
410 polymer repeat unit formed from TMD and DDA
510 polymer repeat unit formed from 1,5-pentanediamine and DDA
610 polymer repeat unit formed from HMD and DDA
612 polymer repeat unit formed from HMD and DDDA
6 polymer repeat unit formed from [symbol] -caprolactam
11 polymer repeat unit formed from 11-aminoundecanoic acid
12 polymer repeat unit formed from 12-aminododecanoic acid

Note that in the art the term “6” when used alone designates a polymer repeat unit formed from [symbol] -caprolactam. Alternatively “6” when used in combination with a diacid such as T, for instance 6T, the “6” refers to HMD. In repeat units comprising a diamine and diacid, the diamine is designated first. Furthermore, when “6” is used in combination with a diamine, for instance 66, the first “6” refers to the diamine HMD, and the second “6” refers to adipic acid. Likewise, repeat units derived from other amino acids or lactams are designated as single numbers designating the number of carbon atoms.

The polyamide resin useful in the invention comprises (i) about 60 to 100 mole percent of repeat units derived from one or more aliphatic dicarboxylic acids and one or more aliphatic diamines, wherein at least about 50 mole percent of the aliphatic dicarboxylic acids and aliphatic diamines are aliphatic dicarboxylic acids and/or aliphatic diamines that have 10 or more carbon atoms, and optionally, 0 to about 40 mole percent of repeat units derived from one or more aromatic dicarboxylic acids. The polyamide resin may be fully aliphatic or semi-aromatic.

The polyamide resin may consist essentially of 70 to 100 mole percent of repeat units derived from one or more aliphatic dicarboxylic acids and one or more aliphatic diamines and 0 to about 30 mole percent of repeat units derived from one or more aromatic dicarboxylic acids.

Suitable aliphatic dicarboxylic acids for polyamide resins useful in the invention include, but are not limited to aliphatic carboxylic acids, such as for example adipic acid (C6), pimelic acid (C7), suberic acid (C8), and azelaic acid (C9). Suitable aliphatic dicarboxylic acids that have 10 or more carbon atoms include, but are not limited to, decanedioic acid (C10), dodecanedioic acid (C12), tridecanedioic acid (C13), tetradecanedioic acid (C14), and pentadecanedioic acid (C15).

Suitable aromatic dicarboxylic acids for polyamide resins useful in the invention include, but are not limited to, terephthalic acid, isophthalic acid, phthalic acid, 2-methyl terephthalic acid and naphthalic acid. Preferred aromatic dicarboxylic acids are terephthalic acid and isophthalic acid.

Suitable aliphatic diamines for polyamide resins useful in the invention include, but are not limited to, tetramethylene diamine, hexamethylene diamine, octamethylene diamine, 2-methylpentamethylene diamine, 2-ethyltetramethylene diamine, 2-methyloctamethylenediamine; trimethylhexamethylenediamine.

Suitable aliphatic diamines that have 10 or more carbon atoms include, but are not limited to, decamethylene diamine, dodecamethylene diamine, and tetradecamethylene diamine. Preferred aliphatic diamines that have 10 or more carbon atoms are decamethylene diamine and dodecamethylene diamine.

Polyamides are condensation products of one or more dicarboxylic acids and one or more diamines, and/or one or more aminocarboxylic acids, and/or ring-opening polymerization products of one or more cyclic lactams. Suitable cyclic lactams are caprolactam and laurolactam.

In one embodiment the polyamide composition consists essentially of one or more polyamide resins selected from the group consisting of poly(hexamethylene decanediamide) (PA610), poly(hexamethylene dodecanediamide) (PA612), poly(decamethylene decanediamide) (PA1010), and poly(hexamethylene dodecanediamide)/hexamethylene terephthalamide (PA612/6T), wherein said PA612/6T has a 6T repeat unit present at 20 to 30 mol percent.

The one or more fiber reinforcing agents wherein said fiber has an average length of 0.1 to 0.9 mm can be selected from the group consisting of glass fiber, carbon fiber, and a mixture thereof. The glass fiber can be of circular or noncircular cross-section.

Glass fibers with noncircular cross-section refer to glass fiber having a to cross section having a major axis lying perpendicular to a longitudinal direction of the glass fiber and corresponding to the longest linear distance in the cross section. The non-circular cross section has a minor axis corresponding to the longest linear distance in the cross section in a direction perpendicular to the major axis. The non-circular cross section of the fiber may have a variety of shapes including a cocoon-type (figure-eight) shape, a rectangular shape; an elliptical shape; a roughly triangular shape; a polygonal shape; and an oblong shape. As will be understood by those skilled in the art, the cross section may have other shapes. The ratio of the length of the major axis to that of the minor access is preferably between about 1.5:1 and about 6:1. The ratio is more preferably between about 2:1 and 5:1 and yet more preferably between about 3:1 to about 4:1. Suitable glass fiber are disclosed in EP 0 190 001 and EP 0 196 194.

The injection molded composite wheel, optionally, comprises 0 to 20 weight percent of one or more polymer impact modifiers. The polymer impact modifiers comprise a reactive functional group and/or a metal salt of a carboxylic acid.

In one embodiment the injection molded composite wheel comprises 2 to 20 weight percent, and preferably 5 to 12 weight percent polymer impact modifiers. In another embodiment the polymer impact modifiers are selected from the group consisting of: a copolymer of ethylene, glycidyl (meth)acrylate, and optionally one or more (meth)acrylate esters; an ethylene/α-olefin or ethylene/α-olefin/diene copolymer grafted with an unsaturated carboxylic anhydride; a copolymer of ethylene, 2-isocyanatoethyl (meth)acrylate, and optionally one or more (meth)acrylate esters; and a copolymer of ethylene and acrylic acid reacted with a Zn, Li, Mg or Mn compound to form the corresponding ionomer.

In the present invention, the polyamide composition may also comprise additives used in the art, such heat stabilizers or antioxidants, antistatic agents, lubricants, plasticizers, and colorant and pigments. Heat stabilizers include polyhydric alcohols such as dipentaerythritol, copper stabilizers, hindered phenols, and mixtures thereof.

Herein the polyamide composition is a mixture by melt-blending, in which all polymeric ingredients are adequately mixed, and all non-polymeric ingredients are adequately dispersed in a polymer matrix. Any melt-blending method may be used for mixing polymeric ingredients and non-polymeric ingredients of the present invention. For example, polymeric ingredients and non-polymeric ingredients may be fed into a melt mixer, such as single screw extruder or twin screw extruder, agitator, single screw or twin screw kneader, or Banbury mixer, and the addition step may be addition of all ingredients at once or gradual addition in batches. When the polymeric ingredient and non-polymeric ingredient are gradually added in batches, a part of the polymeric ingredients and/or non-polymeric ingredients is first added, and then is melt-mixed with the remaining polymeric ingredients and non-polymeric ingredients that are subsequently added, until an adequately mixed composition is obtained. The one or more fiber reinforcing agents may be added at the beginning of blending or at sometime during the blending process.

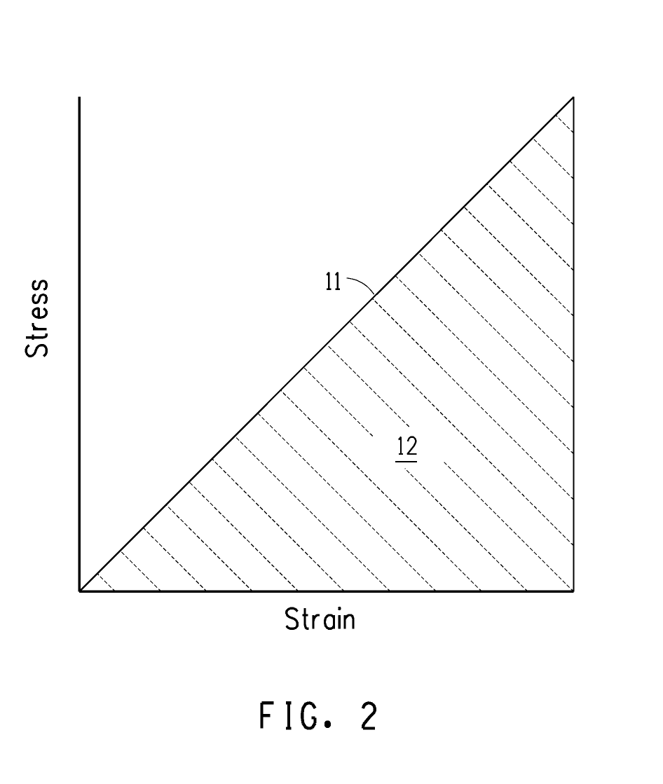

Elongation is a key indicator for material toughness. Toughness is a measure of the energy a sample can absorb before it breaks. FIG. 2 shows an idealized stress-strain curve (11). The energy absorption is characterized by an area under stress-strain curve (12) in tensile testing. When comparing materials of similar tensile strength, the higher the elongation at break, the higher the energy absorption and the higher the toughness.

The present invention is further defined in the following examples. It should be understood that these examples, while indicating preferred embodiments of the invention, are given by way of illustration only. From the above discussion and these examples, one skilled in the art can ascertain the essential characteristics of this invention, and without departing from the spirit and scope thereof, can make various changes and modifications of the invention to adapt it to various uses and conditions.

### Methods

### Test Methods

Tensile strength, elongation at break, and tensile modulus were tested on a tensile tester from Instru-Met Corporation by ISO 527-1/-2 at 23° C. and strain rate of 5 mm/min on samples that were dry as molded.

Notched Izod was tested on a CEAST Impact Tester by ISO 180 at 23° C. on a Type 1A multipurpose specimen with the end tabs cut off. The resulting test sample measures 80×10×4 mm. (The depth under the notch of the specimen was 8 mm). Specimens were dry as molded.

Un-notched Izod was tested on a CEAST Impact Tester by ISO 180 at 23° C. on a Type 1A multipurpose specimen with the end tabs cut off. The resulting test sample measures 80×10×4 mm. Specimen were dry as molded.

Dynatup drop weight impact test was performed according to ASTM D3763 using a 10000 LB cell at 23° C. The samples were molded 4 inch diameter disc of 0.125 inch thickness. The ring size was 0.5 inch and the drop speed was 3.2 m/second. The results of this test are listed in Table 2.

### Impact Tests of Wheel Test Specimens

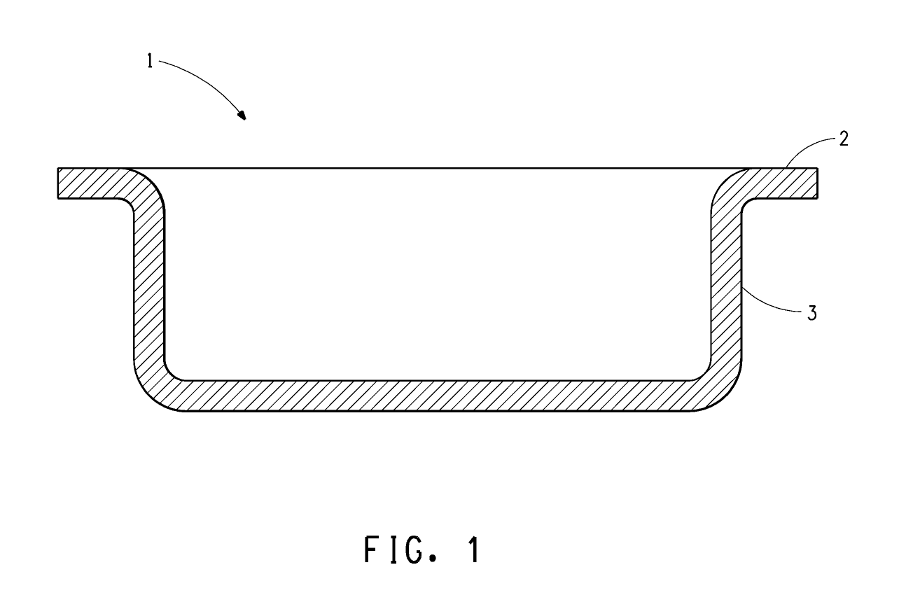

FIG. 1 illustrates a cross-sectional view of a wheel test specimen used in an upward and downward (throw-down) impact test. The wheel test specimen was a tub (1) nominally about 10 inches in diameter by 4 inches deep, with a flange (2) approximately 0.75 inches in annular width, projecting outwardly at about a 90 degree angle from the tub wall (3), running around the open end of the tub.

The tubs were injection molded using the following procedure: pelletized compositions were dried in a desiccant (dew point of −40° F.) dryer at 180° F. for 5 hours and were then fed into a 500 Ton Van Dorn injection molding machine and processed using a general purpose screw at a melt temperature of about 580 to 590° F., and a mold temperature of 255 to 265° F., with core temperatures of 275 to 280° F. The thickness of the tub was about 0.200 to 0.250 inches. The molded components were allowed to rest 10 to 12 hours to cool and relax stress due to the molding process.

### Upward Vertical Impact Test

The tub was taken in hand grasping the flange such that the fingers wrap onto the inner surface of the tub and the palm of the hand rests on the outside wall of the tub. Holding the tub firmly, the tub was swung back by the arm approximately 45 degrees, and then thrown in the air to at least 25 feet to about 30 feet, as nearly vertical as possible, attempting to cause the tub to rotate about its axis, and allowing the tub to fall onto a level open area, paved with concrete. The tub was inspected for cracks. The number of times the tub had to be thrown to provide a crack by visual inspection was recorded

### Downward Impact Test

An operator grasped the tub as disclosed above, took a small step back with the foot on the same side as the hand holding the tub, and swung the tub back and 360 degrees around and threw overhand onto a level open area, paved with concrete, at as close to vertical to the concrete as possible. The tub was inspected for cracks. The number of times the tub had to be thrown to provide a crack by visual inspection was recorded.

The tub is considered of marginal performance if there are cracks evident after 5 cycles, and acceptable performance is no cracks after 10 cycles through each procedure. Highly desirable performance is no cracks after 15 cycles through each procedure. Tubs showing no cracks after 15 cycles indicate the material comprising the tub is appropriate for use in demanding dynamic structural applications such as ATV wheels.

### Materials

PA66 refers to an aliphatic polyamide made of 1,6-hexanedioic acid and 1,6-hexamethylenediamine having an relative viscosity in the range of 46-51 and a melting point of about 263° C., available from E.I. DuPont de Nemours and Company, Wilmington, Del., USA under the trademark Zytel® 101NC010.

PA6 refers to Ultramid® 827 poly(ε-caprolactam) available from BASF, USA.

PA610 refers to Zytel®FE310064 polyamide 610 made from 1,6-diaminohexane and 1,10-decanedioic acid available from E.I. DuPont de Nemours and Company, Wilmington, Del., USA.

Polyamide 1010 is a polyamide 1010 (Type 12) made from 1,10-decanedioic acid and 1,10-daiminodecane by Xinda Corporation, Wuxi, China.

PA612/6T copolymer made from 1,6-diaminohexane, 75 mole percent 1,12-dodecanedioic acid, and 25 mole percent terephthalic acid available from E.I. du Pont de Nemours and Company, Wilmington, Del. (Zytel®FE310054).

Glass Fiber refers to ChopVantage® 3660 chopped glass fiber (nominal length 3.2 mm) available from PPG Industries, Pittsburgh, Pa. 15272, USA.

Glass Roving refers to PPG4588 glass roving (continuous fiber) available from PPG Industries, Pittsburgh, Pa. 15272, USA.

Carbon fiber refers to Panex® 35 carbon fiber (nominally 0.8 cm long) to manufactured by Zoltek Corp., Bridgeton, Mo. 63304, USA. In compounding, this fiber breaks down to provide average fiber lengths typically less than 0.5 mm.

Engage® 8180 copolymer is an ethylene/ctane copolymer from Dow Chemical, Houston, Tex., USA.

TRX®301 copolymer is maleic anhydride modified EPDM available from E.I. DuPont de Nemours and Company, Wilmington, Del., USA.

Color concentrate I refers to 44% carbon black master batch in polyamide terpolymer available from Americhem Inc., Cuyahoga, Ohio, USA).

Color concentrate II refers to 20% carbon black master batch in polyamide 6 available from Clariant Corp.

Color concentrate III refers to 40% Nigrosin master batch in polyamide 6 available from Dupont, Wilmington, Del.

Cu heat stabilizer refers to a mixture of 7 parts of potassium iodide and 1 part of copper iodide in 0.5 part of a stearate wax binder.

Licomont® CaV 102 fine grain is calcium salt of montanic acid available from Clariant Corp., 4132 Mattenz, Switzerland.

Aluminum Distearate is a wax supplied by PMC Global, Inc. Sun Valley, Calif., USA.

### Examples 1-4 and C1-C2

The compositions listed in Table 1 were compounded with a 26˜30 mm 10-barrel twin screw extruder at 250 RPM screw speed, 30 pounds per hour throughput, and barrel temperature setting of 270-290° C. All ingredients were fed from the back of the extruder except the glass fiber which was fed from side of the extruder. The compounded pellets were dried and molded into 4 mm ISO multipurpose tensile bars on a Nessei Injection Molding Machine FN3000 with a melt temperature of 280-285° C. and with a general compression screw. The results of Physical testing are listed in Table 1.

Examples 1-4 show tensile modulus of 9 Gpa or greater indicating the compositions are suitably stiff, and yet the Examples exhibit substantially higher elongation at break than the comparative examples, from 33% to 150% higher elongation.

TABLE 1

| | Example | | | | | |
|---|---|---|---|---|---|---|
| | C1 | C2 | 1 | 2 | 3 | 4 |
| PA66 | 59.35 | 49.96 | | | | |
| PA1010 | | | 59.35 | | 49.96 | |
| PA612/6T | | | | 59.35 | | 49.96 |
| Engage 8180 | | 5.64 | | | 5.64 | 5.64 |
| TRX-301 | | 3.75 | | | 3.75 | 3.75 |
| Glass fiber | 40 | 40 | 40 | 40 | 40 | 40 |
| Cu heat | 0.4 | 0.4 | 0.4 | 0.4 | 0.4 | 0.4 |
| stabilizer | | | | | | |
| Licomont ® | 0.25 | 0.25 | 0.25 | 0.25 | 0.25 | 0.25 |
| CaV 102 | | | | | | |
| Total | 100 | 100 | 100 | 100 | 100 | 100 |

Physical Properties

| | | | | | | |
|---|---|---|---|---|---|---|
| Tensile | 224 | 169 | 175 | 187 | 147 | 175 |
| strength | | | | | | |
| (Mpa) | | | | | | |
| Tensile | 13.5 | 11.6 | 11 | 12 | 10 | 9 |
| Modulus | | | | | | |
| (Gpa) | | | | | | |
| Elongation (%) | 3.02 | 2.93 | 4.9 | 4 | 7.5 | 6 |
| Notched Izod | 13.5 | 21.2 | 21 | 17 | 35.9 | 31.6 |
| (KJ/m2) | | | | | | |
| Unnotched | 78 | 84.6 | 100 | 83 | 121 | 107 |
| Izod (KJ/m2) | | | | | | |

### Examples 5, 6 and C3, C4, and C5

The compositions of Examples 5, 6 and C3 listed in Table 2 were compounded with a 58 mm 10-barrel twin screw extruder at about 300 RPM screw speed, about 600 pounds per hour throughput, and melt temperature of 330-340° C.

Composition C4 was compounded with a 26-30 mm 10-barrel twin screw extruder at 250 RPM screw speed, 30 pounds per hour throughput, and barrel temperature setting of 270-290° C. All ingredients were fed from the back of the extruder except the glass fiber and carbon fiber, which were fed from side of the extruder.

The compounded pellets were dried and molded into 4 mm ISO multipurpose tensile bars on a Nessei Injection Molding Machine FN3000 with a melt temperature of 280-285° C. and with a general compression screw. The results of Physical testing are listed in Table 2.

Composition C5 was made on a pultrusion machine and cut into 11-14 mm pellets after processing.

Wheel test specimens in the form of tubs were injection molded and tested using the procedure disclosed in “Impact tests of wheel test specimens.”

Examples 5 (PA612/6T) and 6 (PA610), at the same level of impact modifier and glass fiber as the Comparative Example C3 (PA66/PA6 blend) showed comparable tensile modulus to C3, yet exhibited about 50 to 66% higher elongation to break. The Upward vertical impact test and downward impact tests on test tubs indicated that Examples 5 and 6 exhibited surprising and unexpected improvement in performance relative to that of comparative example C3 and indicates that the relatively high elongation to break, that is 4% or more, correlated with improved resistance to crack failure in the test tubs.

Comparative Example C4 comprising PA610 with no polymer impact modifier exhibited a 3.35% elongation.

Comparative Example C5 shows that long glass fiber made using a pultrusion process exhibits an elongation at break of only 2.2%.

TABLE 2

| | Example | | | | |
|---|---|---|---|---|---|
| | C3 | 5 | 6 | C4 | C5 |
| PA66 | 29.81 | | | | 55.2 |
| PA6 | 17.71 | | | | 3.62 |
| PA612/6T | | 49.16 | | | |
| PA610 | | | 49.16 | 59.35 | |
| Engage 8180 | 5.64 | 5.64 | 5.64 | | |
| TRX-301 | 3.75 | 3.75 | 3.75 | | |
| Glass fiber | 30 | 30 | 30 | 40 | |
| Carbon fiber | 10 | 10 | 10 | | |
| Cu heat stabilizer | 0.4 | 0.4 | 0.4 | 0.4 | 0.3 |
| Glass roving | | | | | 40 |
| Color concentrate I | 2.44 | | | | |
| Color concentrate II | | 0.8 | 0.8 | | |
| Color concentrate III | | | | | 0.875 |
| Licomont ® CaV 102 | 0.25 | | | 0.25 | |
| Aluminum distearate | | 0.25 | 0.25 | | 0.1 |
| Total | 100 | 100 | 100 | 100 | 100 |

Physical Properties

| | | | | | |
|---|---|---|---|---|---|
| Tensile strength (Mpa) | 172 | 155 | 167 | 184 | 240 |
| Tensile Modulus (Gpa) | 14.5 | 14 | 15 | 12 | 14 |
| Elongation (%) | 2.94 | 4.94 | 4.38 | 3.35 | 2.2 |
| Notched Izod (KJ/m2) | 16.4 | 28.5 | 26.5 | 16.4 | 35 |
| Unnotched | 78 | 90.8 | 84.3 | 77 | 70 |
| Izod (KJ/m2) | | | | | |
| Upward impact test, | 5 | 7 | 10 | | |
| # of throws^{a} | | | | | |
| Downward impact test | 4 | 25 | 30 | | |
| # of throws^{a} | | | | | |

Dynatub Impact Strength, 23° C.

| | | | | | |
|---|---|---|---|---|---|
| Total energy (J) | 13.93 | 17.2 | 16.56 | 5.05 | 12.03 |
| Time to fail (ms) | 1.9 | 2.3 | 2.21 | 1.23 | 1.47 |
| Energy to fail (J) | 13.77 | 17.04 | 16.45 | 4.67 | 8.84 |

^{a}Samples allowed to rest at least 2 hours before testing

We claim:

1. A injection molded composite wheel, comprising a polyamide composition consisting essentially of
(A) about 20 to about 70 weight percent of at least one polyamide resin comprising,
i. about 60 to 100 mole percent of repeat units derived from one or more aliphatic dicarboxylic acids and one or more aliphatic diamines, wherein at least about 50 mole percent of the aliphatic dicarboxylic acids and aliphatic diamines are aliphatic dicarboxylic acids and/or aliphatic diamines that have 10 or more carbon atoms, and
ii. 0 to about 40 mole percent of repeat units derived from one or more aromatic dicarboxylic acids,
(B) about 30 to about 65 weight percent of one or more fiber reinforcing agents wherein said fiber has an average length of 0.1 to 0.9 mm; and
(C) 0 to about 20 weight percent of one or more polymer impact modifiers;
wherein the weight percentages of (A), (B), and (C) are based on the total weight of (A)+(B)+(C), and wherein 4 mm test bars prepared from said polyamide composition have an average tensile modulus greater than or equal to about 9 GPa, as measured by ISO 527-1/2 and an elongation at break of at least 4% as tested according to ISO 527-2/1A; with the proviso that when said at least one polyamide resin consist of PA610, at least 2 weight percent of one or more polymer impact modifiers is present.

2. The composite wheel of claim 1 wherein the at least one polyamide resin comprises 70 to 100 mole percent of repeat units derived from one or more aliphatic dicarboxylic acids and one or more aliphatic diamines and 0 to about 30 mole percent of repeat units derived from one or more aromatic dicarboxylic acids.

3. The composite wheel of claim 1 wherein the at least one polyamide resin is selected from the group consisting of poly(hexamethylene decanediamide) (PA610), poly(hexamethylene dodecanediamide) (PA612), poly(decamethylene decanediamide) (PA1010), and poly(hexamethylene dodecanediamide)/hexamethylene terephthalamide (PA61216T), wherein said PA612/6T has a 6T repeat unit present at 20 to 30 mol percent.

4. The composite wheel of claim 1 wherein (B) one or more fiber reinforcing agents is present at about 30 to about 50 weight percent.

5. The composite wheel of claim 1 wherein one or more fiber reinforcing agents is selected from glass fiber, carbon fiber, or a mixture thereof.

6. The composite wheel of claim 1 that consists essentially of (A) about 25 to about 65 weight percent of at least one polyamide resin, about 30 to about 65 weight percent of one or more fiber reinforcing agents; and (C) 5 to about 12 weight percent of one or more polymer impact modifiers.
